(19) United States
(12) Patent Application Publication
(10) Pub. No.: US 2020/0140638 A1
(43) Pub. Date: May 7, 2020

(54) METHOD FOR PRODUCING ELECTROCONDUCTIVE FILM

(71) Applicant: Sumitomo Riko Company Limited, Aichi (JP)

(72) Inventors: Yutaro TAGUCHI, Aichi (JP); Shigeaki TAKAMATSU, Aichi (JP); Hiroaki ITO, Aichi (JP)

(73) Assignee: Sumitomo Riko Company Limited, Aichi (JP)

(21) Appl. No.: 16/736,826

(22) Filed: Jan. 8, 2020

Related U.S. Application Data
(63) Continuation of application No. PCT/JP2018/023097, filed on Jun. 18, 2018.

(30) Foreign Application Priority Data
Aug. 9, 2017 (JP) 2017-154159

(51) Int. Cl. C08J 5/18; C08K 3/04; C01B 32/22; H01B 1/24

(52) U.S. Cl. CPC C08J 5/18; C08K 3/04; C01B 32/22; H01B 1/24; C08J 2300/26; C08K 2201/003; C01P 2006/10; C01P 2004/61; C08L 2203/16; C08K 2201/001

(57) ABSTRACT

A method for manufacturing an electroconductive film includes a liquid composition preparation step for preparing a liquid composition including an electroconductive agent, an elastomer, and a solvent, the electroconductive agent having thinned graphite in which layers of graphite are thinned and which has a bulk density of 0.05 g/cm3 or lower; a delamination treatment step for performing interlayer delamination of the thinned graphite by pressurizing the liquid composition and passing same through a nozzle; and a hardening step for coating a substrate with the delamination-treated liquid composition and hardening a coated film. According to the method, thinning of the graphite processes sufficiently and the thinning process can be performed in shorter time than conventionally possible, and makes it also possible to manufacture an electroconductive film that has high electroconductivity and has electrical resistance unlikely to increase even after repeated extension.

### CROSS-REFERENCE TO RELATED APPLICATION

The present application is a continuation of PCT/JP2018/023097, filed on Jun. 18, 2018, and is related to and claims priority from Japanese patent application no. 2017-154159, filed on Aug. 9, 2017. The entire contents of the aforementioned application are hereby incorporated by reference herein.

### TECHNICAL FIELD

The present disclosure relates to a method for manufacturing an electroconductive film that is suitable for an electrode or a wiring of a flexible transducer using a polymer material, an electromagnetic wave shield, a flexible wiring board, and the like.

### RELATED ART

A highly flexible, small-sized, and light-weight transducer has been developed using a polymer material such as an elastomer. Such a type of transducer is configured with a dielectric layer made of an elastomer interposed between electrodes, for example. If a voltage applied between the electrodes is caused to change, the dielectric layer expands or contracts. Therefore, the electrodes and the wiring are required to have elasticity that allows the electrodes and the wiring to follow the deformation of the dielectric layer. As an elastic material for the electrodes and the wiring, an electroconductive rubber composition in which an electroconductive agent such as a carbon material is blended into rubber as disclosed in Patent Literature 1 (Japanese Laid-open No. 2009-227985), for example, is known.

In a case in which electroconductive carbon black or graphite powder among carbon materials that are used as electroconductive agents is blended in an elastomer, it becomes difficult for particles to be brought into contact with each other, and areas at contact points are also small. Therefore, it can not but increase the amount of the electroconductive agent that is blended in in order to apply desired electroconductivity to the composition, and flexibility deteriorates. Also, since conductivity due to the contact between the particles is cut if the composition is extended, electric resistance significantly increases. Meanwhile, in a case in which multilayer carbon nanotubes with a relatively large aspect ratio are blended into an elastomer, the multilayer carbon nanotubes easily come into contact with each other while conductivity of the multilayer carbon nanotubes themselves is low, and electric resistance of the composition thus increases. Therefore, there is a limit to increasing electroconductivity of the composition while maintaining flexibility. Also, single-layer carbon nanotubes and graphene (a constituent unit of graphite) have a relatively large aspect ratio and high electroconductivity. However, since the single-layer carbon nanotubes or graphene tends to aggregate, an increase in viscosity increases in a case in which the single-layer carbon nanotubes or graphene is caused to be dispersed in an elastomer solution to form a paint. Therefore, it is difficult to form a thin film by a print method or the like.

As a material with various excellent properties such as electroconductivity and heat conductivity, thinned graphite obtained through interlayer delamination of graphite or the like is known. As a method for manufacturing thinned graphite, Patent Literature 2 (Japanese Patent No. 6152306), for example, discloses a method of bringing an intercalant in a supercritical state or a subcritical state into contact with graphite and then gasifying the intercalant that has entered between layers of graphite. Patent Literature 3 (Japanese Laid-open No. 2011-190166) discloses a method of bringing a high-pressure fluid that is a supercritical fluid or a subcritical fluid into contact with a graphite compound and then reducing a pressure applied to the high-pressure fluid. Patent Literature 4 (Japanese Laid-open No. 2014-009151) discloses a method of causing a suspension obtained by causing graphite or a graphite compound to be suspended in a dispersion medium to pass through fine pores and performing delamination between graphite or graphite compound layers by a high-pressure emulsification method. Patent Literature 5 (US Patent Publication No. 2009/0224211) describes a method of pressure-sending a dispersion including graphite powder to a reaction chamber at a high pressure and delaminating graphite with a shear force.

However, a graphite material has a structure (stacking structure) in which graphene with six-membered rings of carbon atoms successively aligned in a plane is piled up and adjacent layers fixedly aggregate through a π-π interaction. Therefore, it is difficult to proceed with adequate thinning of the graphite layers by a conventional method such as a high-temperature high-pressure treatment or a high-pressure emulsification method as described in Patent Literatures 2 to 5. If the graphite layers are not adequately thinned, it is difficult to obtain desired electroconductivity even if a conductive film is manufactured by adding an elastomer thereto, and repeated extension may lead to an increase in electric resistance. Also, since it is difficult to proceed with thinning of the graphite layers according to the conventional method, it takes time to perform the treatment for thinning the layers.

The present disclosure provides a method for manufacturing an electroconductive film that makes it possible to proceed with adequate thinning of the graphite and perform the thinning process in short time than was conventionally possible, and also makes it possible to manufacture an electroconductive film that has high electroconductivity and in which electrical resistance is unlikely to increase even after repeated extension.

### SUMMARY

In view of the above description, the disclosure provides a method for manufacturing an electroconductive film including: a liquid composition preparation step of preparing a liquid composition including an electroconductive agent, an elastomer, and a solvent, the electroconductive agent having thinned graphite in which layers of graphite are thinned and which has a bulk density of equal to or less than 0.05 g/cm³; a delamination treatment step of performing interlayer delamination of the thinned graphite by pressurizing the liquid composition and causing the liquid composition to pass through a nozzle; and a hardening step of coating a substrate with the delamination-treated liquid composition and hardening a coated film.

### BRIEF DESCRIPTION OF DRAWINGS

FIG. 1 is a graph illustrating initial volume resistivities of electroconductive films in an example and a comparative example.

FIG. 2 is a graph illustrating maximum volume resistivities in an extension durability test conducted on the electroconductive films.

FIG. 3 is a graph illustrating maximum magnifications of change in electric resistance values in the extension durability test conducted on the electroconductive films.

### DESCRIPTION OF EMBODIMENTS

A method for manufacturing an electroconductive film according to the disclosure has a liquid composition preparation step, a delamination treatment step, and a hardening step. Hereinafter, the respective steps will be described in order.

[Liquid Composition Preparation Step]

This step is a step of preparing a liquid composition that includes an electroconductive agent including thinned graphite in which layers of graphite are thinned an which has a bulk density of equal to or less than 0.05 g/cm³, an elastomer, and a solvent.

The thinned graphite is obtained by performing interlayer delamination of the graphite, and the number of laminated graphene layers is smaller than that of graphite. Graphene corresponds to one layer of graphite and has a structure in which six-membered carbon atoms are successively aligned in a plane shape. The number of laminated graphene layers in the thinned graphite may be several hundred to several thousand. The bulk density of the thinned graphite is equal to or less than 0.05 g/cm³. In the specification, the bulk density of the thinned graphite is measured as follows. An arbitrary amount of the thinned graphite is poured into a 50 ml measuring cylinder, and the mass and the volume thereof are measured. Then, a value obtained by dividing the measured mass by the volume is a bulk density. In addition, the volume was measured as a loose bulk volume without compressing the thinned graphite.

The particle diameter of the thinned graphite may be relatively large within a range in which a delamination treatment that will be described later can be performed. If the particle diameter of the thinned graphite is small, the size of the multilayer graphene obtained after the delamination treatment in a plane direction becomes small. In this case, there is concern that it will be more difficult for the multilayer graphene particles to come into contact with each other. As a result, there is a concern that the initial electroconductivity and the electroconductivity after repeated extension may be degraded. For such a reason, it may to use the thinned graphite powder with an average particle diameter of equal to or greater than 45 μm. In the specification, a median diameter measured using a particle diameter distribution measurement device of a laser diffraction scattering scheme (“Microtrac MT3000” manufactured by MicrotracBell Corporation) is employed as an average particle diameter of the thinned graphite powder. As a sample for measuring the particle diameter distribution, a dispersion (refractive index: 1.38) in which a powder that is a measurement target is dispersed in methyl ethyl ketone is used.

The method for manufacturing the thinned graphite is not particularly limited. For example, it is possible to easily manufacture the thinned graphite by the following method. That is, a method for manufacturing the thinned graphite has a contact step of bringing an intercalant in a supercritical state or a subcritical state into contact with graphite and causing the intercalant to enter between the graphite layers and a gasification step of gasifying the intercalant that has entered between the graphite layers.

“Intercalant” refers to molecules that enter between the graphite layers. As the intercalant, carbon dioxide, water, oxygen, methyl alcohol, ammonium, and the like are exemplified. The intercalant that is in the form of a gas at ordinary temperature and ordinary pressure (the temperature is equal to or greater than 273.15 K and equal to or less than 313.15 K, and the pressure is equal to or greater than 870 hPa and equal to or less than 1083 hPa) may be used. Examples of the intercalant that is in the form of a gas at ordinary temperature and pressure include carbon dioxide.

The supercritical state is a state at a temperature that is equal to or greater than a temperature at a critical point (critical temperature) and at a pressure that is equal to or greater than a pressure at a critical point (critical pressure). The subcritical state is a state at a temperature that is slightly lower than the critical temperature or a state at a pressure that is slightly lower than the critical pressure in the vicinity of the critical point. In particular, the following three states are subcritical states. A first state is a state in which a ratio between the temperature and the critical temperature of the intercalant is equal to or greater than 0.9 and less than 1.0 and the pressure of the intercalant is equal to or greater than the critical pressure. A second state is a state in which the temperature of the intercalant is equal to or greater than the critical temperature and a ratio between the pressure and the critical pressure of the intercalant is equal to or greater than 0.9 and less than 1.0. The third state is a state in which the ratio between the temperature and the critical temperature of the intercalant is equal to or greater than 0.9 and less than 1.0 and the ratio between the pressure and the critical pressure of the intercalant is equal to or greater than 0.9 and less than 1.0. In addition, the unit of temperature is kelvins (K), and the unit of pressure is pascals (P) in these three states.

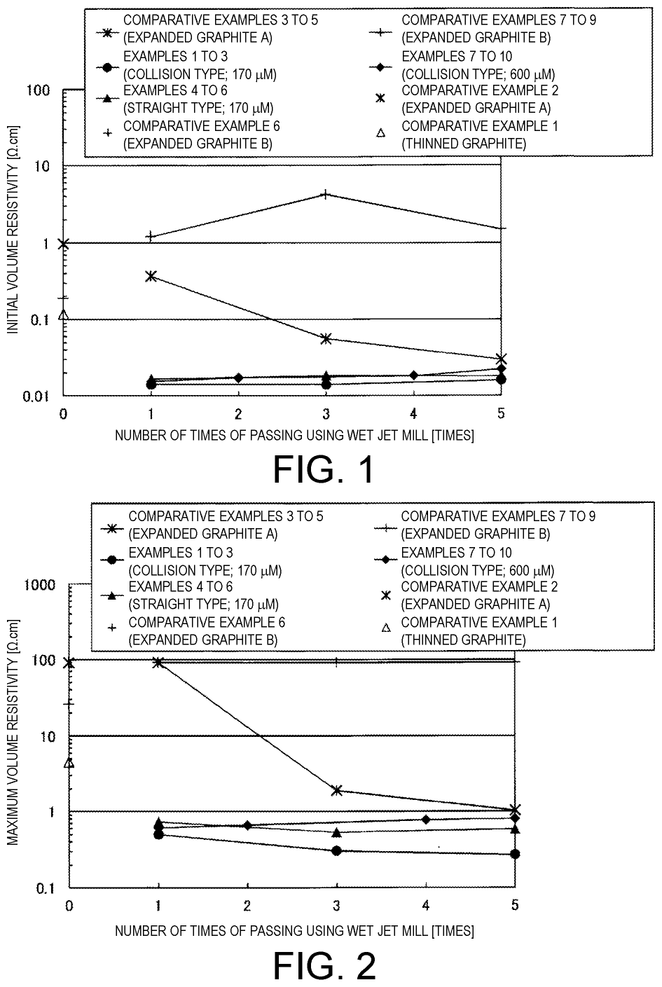

In the contact step, a method of bringing the intercalant in the supercritical state or the subcritical state into contact with the graphite is not particularly limited. It is only necessary to cause the intercalant in the supercritical state or the subcritical state to flow into a reaction container with the graphite accommodated therein and to maintain a state in which the graphite and the intercalant are mixed in a predetermined time using the chemical reaction device described in Paragraphs [0029] to [0031] and FIG. 1 in Patent Literature 2 (Japanese Patent No. 61523306), for example.

A method of gasifying the intercalant that has entered between the graphite layers in the gasification step is not particularly limited. For example, it is only necessary to cause the pressure applied to the intercalant to drop. In a case of using an intercalant that is in the form of a gas at ordinary temperature and ordinary pressure (carbon dioxide, for example), it is possible to easily gasify the intercalant by exposing the mixture of the graphite and the intercalant to atmosphere. If the intercalant is gasified, delamination between the graphite layers occurs. In this manner, the thinned graphite is manufactured.

The method for manufacturing the thinned graphite may have a heating step of heating the graphite before the contact step. For example, a substance that generates a gas through heating is inserted between the graphite layers in the expanded graphite. Therefore, it is possible to cause the graphite to be expanded and to cause delamination between the layers by heating the graphite before the contact step in a case of using the expanded graphite as graphite. The heating step and the contact step may be performed once or may be repeated. Also, a reheating step of reheating the graphite may be performed after the contact step (after the last contact step in a case in which the heating step and the contact step are repeated) in a case in which the heating step is performed.

A method of heating the graphite in the heating step and the reheating step is not particularly limited. For example, the graphite may be heated in a furnace, or may be irradiated with microwaves. In the latter case, although energy of the microwaves for irradiation is not particularly limited, the energy may be equal to or greater than 500 watts and equal to or less than 700 watts. In addition, the volume resistivity of the obtained thinned graphite decreases if a space in which the graphite is accommodated is depressurized before the graphite is heated and the graphite is further heated under a reduced pressure in the heating step as compared with a non-depressurized case.

The amount of the thinned graphite blended in the electroconductive agent may be equal to or greater than 20 parts by mass and equal to or less than 60 parts by mass on the assumption that the entire solid amount except for the electroconductive agent is 100 parts by mass. In a case in which the amount is less than 20 parts by mass, it is difficult for the thinned graphite (multilayer graphene) particles to come into contact with each other in the manufactured electroconductive film, and thus it becomes difficult to form the conductive path that is durable against extension. On the other hand, if the amount exceeds 60 parts by mass, it becomes difficult to manufacture a flexible electroconductive film.

The liquid composition may include an electroconductive agent other than the thinned graphite. The electroconductive agent is a material that makes the electroconductive film have electroconductivity. As another electroconductive agent, electroconductive carbon black, carbon nanotubes, or the like may be used. In a case in which electroconductive carbon black is included, for example, it is possible to allow the electroconductive carbon black to serve as a thickener to adjust viscosity of the liquid composition or to improve the strength of the electroconductive film.

As an elastomer, an elastomer with a glass transition temperature (Tg) of equal to or less than room temperature may be used from the viewpoint that such an elastomer has rubber-like elasticity at an ordinary temperature. Crystallinity deteriorate as Tg decreases. Therefore, the elastomer is more easily extended. For example, Tg of an elastomer may be equal to or less than 0° C., equal to or less than −10° C., or equal to or less than −30° C., and the elastomer is more flexible.

The elastomer may be crosslinked rubber due to its excellent restoring properties in a case in which deformation is repeated. Also, a pseudo-crosslinked elastomer that has a micro-phase separation structure of hard segments and soft segments, such as a thermoplastic elastomer, may also be used. Examples of the thermoplastic elastomer include an olefin-based elastomer, a styrene-based elastomer, a polyester-based elastomer, an acrylic elastomer, a urethane-based elastomer, a vinyl chloride-based elastomer, and the like. Examples of the crosslinked rubber include urethane rubber, acrylic rubber, silicone rubber, butyl rubber, butadiene rubber, an ethylene oxide-epichlorohydrin copolymer, nitrile rubber, hydrogenated nitrile rubber, chloroprene rubber, natural rubber, isoprene rubber, styrene-butadiene rubber, ethylene-propylene-diene copolymer (EPDM), polyester rubber, and fluorine rubber. In addition, crosslinked rubber which has been modified by introducing functional groups or the like, such as epoxidized natural rubber, epoxy group-modified acrylic rubber, or carboxyl group-modified hydrogenated nitrile rubber may also be used.

Among them, acrylic rubber has a lower Tg than other kinds of rubber since acrylic rubber has low crystallinity and weak intermolecular force. Therefore, acrylic rubber is flexible, is satisfactorily stretched, and is thus suitable for an electrode of a transducer or the like. As acrylic rubber, acrylic rubber with stretching of equal to or greater than 1000% in a non-crosslinked state and with a tensile strength of equal to or greater than 0.1 MPa, for example, may be used. The stretching in the non-crosslinked state and the tensile strength may use values obtained from a stress-stretching curve measured by the following method. First, an acrylic rubber polymer solution before crosslinking is applied to a base material made of polyethylene terephthalate (PET) after a mold-releasing treatment such that a thickness target value of 500 μm is achieved, and the solution is then dried at 150° C. for 2 hours. Next, the base material with a coated film formed thereon is cut into a size with a width of 10 mm×a length of 40 mm, and the coated film is peeled therefrom, thereby obtaining a test piece. Then, a tensile test is conducted on the test piece using a stationary test machine “AUTOGRAPH AGS-X (100N)” manufactured by Shimadzu Corporation, and the stretching with respect to stress when the test piece is monoaxially stretched at a distance of 20 mm between chucks and at a tensile speed of 100 mm/minute is measured.

In a case in which it is desired to apply heat resistance and abrasion resistance to the electroconductive film, fluorine rubber may be used. If heat resistance of the electroconductive film is increased, it is possible to prevent electric resistance from increasing even after repeated extension at a high temperature. If abrasion resistance of the electroconductive film is increased, abrasion is unlikely to occur even if another member is brought into sliding contact with the electroconductive film at a sliding portion, and it is thus possible to prevent electric resistance from increasing.

In a case in which it is desired to apply cold resistance to the electroconductive film, it may select an elastomer with a low Tg. For example, an elastomer with a Tg of equal to or less than −30° C. may be used. In this case, an elastomer with a low Tg may be used alone or may be blended and used with another elastomer. Also, it is possible to improve cold resistance even if a plasticizer is blended as will be described later. If cold resistance of the electroconductive film is improved, flexibility tends not to deteriorate even at a low temperature, and it is possible to prevent electric resistance from increasing even after repeated extension.

As a solvent, a solvent in which a polymer of the elastomer can be dissolved may be used. For example, it may use butyl cellosolve acetate, acetylacetone, isophorone, or the like. Also, a boiling point of the solvent may be adjusted in accordance with an application method in the hardening step performed later.

The liquid composition may include additives such as a crosslinking agent, a crosslinking accelerator, a crosslinking aid, a dispersant, a plasticizer, a processing aid, an anti-aging agent, a softener, a coloring agent, a defoaming agent, a leveling agent, or a viscosity adjusting agent. A crosslinking agent, a crosslinking accelerator, a crosslinking aid, or the like that contributes to a crosslinking reaction may be appropriately selected in accordance with the type of the elastomer. In a case in which a plasticizer is included, the cold resistance of the electroconductive film is improved. Examples of the plasticizer include adipic acid diester, an ether-ester derivative, and the like. In a case in which a plasticizer is included, the amount of blended plasticizer may be set to be equal to or greater than 5 parts by mass and equal to or less than 35 parts by mass on the assumption that the entire solid content except for the electroconductive agent and the plasticizer is 100 parts by mass.

In a case in which a dispersant is included, aggregation of the thinned graphite is prevented, and dispersing properties are improved. Examples of the dispersant include a polymer surfactant (for example, a high-molecular-weight polyester acid amide amine or the like) having an organic salt structure in which an anion and a cation are ion-boned and a polymer obtained through an amide bond or an imide bond between a polycyclic aromatic constituent and an oligomer constituent. The polycyclic aromatic constituent of the latter polymer has a 7-t interaction and contributes to affinity to the thinned graphite. The polycyclic aromatic constituent has a plurality of cyclic structures including aromatic rings. The number and the alignment of the rings are not particularly limited. The polycyclic aromatic constituent may have any of benzene rings, naphthalene rings, anthracene rings, phenanthrene rings, pyrene rings, perylene rings, and naphthacene rings, for example. In consideration of flexibility, a biphenyl structure in which benzene rings are connected or a structure that has naphthalene rings may be employed. An oligomer constituent with an amide bond or an imide bond with the polycyclic aromatic constituent contributes to affinity to the elastomer. The oligomer constituent that is soluble in the elastomer may be used. In a case in which a dispersant is blended, the amount of blended dispersant may be set to be equal to or greater than 5% by mass and equal to or less than 40% by mass on the assumption that the entire solid content except for the electroconductive agent is 100% by mass.

[Delamination Treatment Step]

This step is a step of performing interlayer delamination on the thinned graphite by pressurizing the liquid composition prepared in the previous process and causing the liquid composition to pass through the nozzle.

When the pressurized liquid composition pass through the nozzle, turbulence, cavitation, collision between the liquid composition and a wall, collision in the liquid composition, and the like occur. In this manner, a shear force is applied to the thinned graphite, and interlayer delamination progresses. The pressure when the liquid composition is caused to pass through the nozzle may be equal to or greater than 60 MPa for the purpose of increasing the flow rate and thus increasing the shear force applied to the thinned graphite. On the contrary, the pressure may be equal to or less than 200 MPa for the purpose of preventing miniaturization of the thinned graphite through pulverization. The nozzle may have various shapes as will be described later. Since an appropriate pressure differs depending on the shape of the nozzle, the appropriate pressure may be set in accordance with a nozzle to be used.

The liquid composition that has been caused to pass through the nozzle may be caused to pass through the nozzle again. That is, the delamination treatment of pressurizing the liquid composition and causing the liquid composition to pass through the nozzle may be repeated twice or more. The number of times the liquid composition is caused to pass through the nozzle may be decided in consideration of how the thinning has progressed. For example, the number may be equal to or greater than once and equal to or less than eight times. From the viewpoint of proceeding with the thinning, the number may be equal to or greater than twice. From the viewpoint of shortening the treatment time, the number may be equal to or less than six times or may be further equal to or less than four times. In a case in which the delamination treatment is repeated twice or more, the pressure applied when the liquid composition is caused to pass through the nozzle, the shape of the nozzle, the nozzle diameter, and the like may be the same or may be changed for each treatment.

Examples of the nozzle include a collision-type nozzle, a straight-type nozzle, and the like. The collision-type nozzle is a nozzle having a structure in which two flow paths intersect one another and is also referred to as a cross-type nozzle, an X-type nozzle, an H-type nozzle, or the like. The straight-type nozzle is a nozzle having a flow path with a straight-line shape and is also referred to as an I-type nozzle. As the straight-type nozzle, there is a nozzle with a slit or a through-hole provided therein. From the viewpoint that it is easy to proceed with the thinning of the thinned graphite, the nozzle may have a shape that easily causes collision between the liquid composition and the wall and collision in the liquid composition. However, in the case of the nozzle of such a type that actively causes the liquid composition to collide against balls, disturbing plates, and the like, the thinned graphite easily breaks due to the collision, and miniaturization through pulverization further easily progresses as compared with delamination due to the shear force. Therefore, it may employ a nozzle that causes a shear force through collision between the liquid composition and the wall and collision in the liquid composition without balls, disturbing plates, and the like.

As a device used in this step, a wet jet mill may be used. According to a wet jet mill, the liquid composition is pressurized with a high-pressure pump, is fed to the nozzle, and is then ejected from the nozzle at a high speed. Then, the thinned graphite in the liquid composition undergoes the delamination treatment through turbulence caused when the liquid composition passes through the nozzle, cavitation, collision against the wall, and collision in the liquid composition. According to the wet jet mill, delamination easily progresses since a shear force is applied to the thinned graphite. In this manner, it is possible to easily obtain multilayer graphene with a thickness in a submicron order to a nanometer order.

[Hardening Step]

This step is a step of applying the liquid composition after the delamination treatment to the base material and hardening the coated film.

A method of applying the liquid composition is not particularly limited. Examples thereof include printing methods such as inkjet printing, flexo printing, gravure printing, screen printing, pad printing, metal mask printing, and lithography, a dipping method, a spraying method, a bar coating method, a dispenser method, and the like. As the base material, a sheet with stretchability or bendability may be used. Examples thereof include crosslinked rubber such as acrylic rubber, EPDM, nitrile rubber, hydrogenated nitrile rubber, urethane rubber, butyl rubber, silicone rubber, chloroprene rubber, or an ethylene-vinyl acetate copolymer, an elastomer sheet made of a thermoplastic elastomer such as an urethane-based elastomer sheet, an ester-based elastomer sheet, an amide-based elastomer sheet, or acrylic elastomer sheet, and a resin sheet made of polyimide, polyamideimide, polyethylene, PET, polyethylene naphthalate (PEN), or the like. In a case in which the electroconductive film obtained through this step is formed on a surface of the stretchable base material, it is possible to cause higher flexibility and the effect that the electric resistance tends not to increase even at the time of extension to be further exhibited. The hardening temperature of the coating may be appropriately decided in consideration of the type of the solvent used, the crosslinking temperature of the elastomer, and the like. The thickness of the electroconductive film may be appropriately decided in accordance with the purpose of use. In a case in which the electroconductive film is used as an electrode or a wiring of a transducer, for example, the thickness of equal to or greater than 1 μm and equal to or less than 500 μm may be employed.

The embodiment of the method for manufacturing a conductive film according to the disclosure has been described above. It is also possible to manufacture an electroconductive film that has high electroconductivity and has electric resistance unlikely to increase even after repeated extension by the following second manufacturing method that is different from the disclosure in terms of promotion of the thinning of graphite. That is, the second method for manufacturing an electroconductive film can be configured to include: (a) a step of preparing an electroconductive agent dispersion that includes an electroconductive agent having thinned graphite in which layers of graphite are thinned and which has a bulk density of equal to or less than 0.05 g/cm³ and a solvent; (b) a delamination treatment step of performing interlayer delamination on the thinned graphite by pressurizing the electroconductive agent dispersion and causing the electroconductive agent dispersion to pass through a nozzle; (c) a step of preparing a liquid composition by adding an elastomer solution including an elastomer and a solvent to the electroconductive agent dispersion after the delamination treatment; and (d) a hardening step of applying the liquid composition to a base material and hardening a coated film. The second manufacturing method is different from the method for manufacturing an electro conductive film according to the disclosure in that the elastomer is not included in the solution on which the delamination treatment of the thinned graphite is performed. The second manufacturing method has an advantage that there is no concern that the molecular weight of a polymer decreases due to the delamination treatment as compared with the manufacturing method according to the invention.

The step (b) is the same as the delamination treatment step of the method for manufacturing an electroconductive film according to the disclosure as described above except than that the delamination treatment is performed on the conductive agent dispersion instead of the liquid composition. Here, the electroconductive agent and the solvent included in the electroconductive agent dispersion are as described above for the method for manufacturing an electroconductive film according to the invention. The solvent may be the same as the solvent that is used for preparing the elastomer solution in the following step (c). In a case in which a dispersant is used, the dispersant may be blended in advance into the electroconductive agent dispersion.

### EXAMPLES

Next, the disclosure will be more specifically described by exemplifying examples.

<Manufacturing of Thinned Graphite>

First expanded graphite powder was irradiated with microwaves for 1 minute, thereby heating the powder (heating step). For the irradiation with the microwaves, a “SERIO (registered trademark) microwave MWO-17J-6(W)” available from Musee Corporation was used. The frequency of the microwaves was 2450 MHz, and energy of the microwaves was 700 W. Next, the heated expanded graphite powder was stored in a reaction container, and carbon dioxide in a supercritical state was fed thereto. In this manner, carbon dioxide in a supercritical state was brought into contact with the expanded graphite powder, and carbon dioxide was caused to enter between the expanded graphite layers (contact step). Carbon dioxide in a supercritical state was generated by pressurizing liquified carbonic acid gas to 30 MPa with a pressurizing pump and heating the gas to 80° C. (353.15 K). After the contact state between the expanded graphite powder and carbon dioxide in a supercritical state was maintained for 1 hour, the substance stored in the reaction container (the mixture of the expanded graphite powder and carbon dioxide in a supercritical state) was caused to flow out to a storage tank. Here, since the storage tank was not tightly closed, carbon dioxide was immediately gasified and flowed out from the storage tank (gasification step). The thinned graphite powder was manufactured in this manner. The bulk density of the obtained thinned graphite powder was 0.028 g/cm³, and the average particle diameter was 84 μm. Also, the specific surface area measured by a BET method was 18.2 m²/g.

<Manufacturing of Electroconductive Film>

Materials shown in Tables 1 to 3 described below were blended in the mass proportions shown in the tables, thereby manufacturing electroconductive films. Details of the materials used were as follows.

[Polymer]

Epoxy group-modified acrylic rubber: “Nipol (registered trademark) AR51” manufactured by Zeon Corporation, Tg=−14° C.

### [Electroconductive Agent]

Expanded graphite powder A: “EC10” manufactured by Ito Graphite Co., Ltd., average particle diameter of 211.7 μm

Expanded graphite powder B: “CMX-20” manufactured by Nippon Graphite Industries, average particle diameter of 38.4 μm

### [Dispersant]

High-molecular-weight polyester acid amide amine salt: “Disparlon (registered trademark) DA7301” manufactured by Kusumoto Chemicals, Ltd.

### [Crosslinking Agent]

Amino group terminated butadiene-acrylonitrile copolymer: “ATBN1300×16” manufactured by CVC Thermoset Specialties Ltd.

### [Crosslinking Accelerator]

Zinc complex: “XK-614” manufactured by King Industries, Inc.

[Method for Manufacturing Electroconductive Films in Examples 1 to 3]

Electroconductive films in Examples 1 to 3 were manufactured by the manufacturing method according to the invention. First, an electroconductive agent (manufactured thinned graphite powder), a dispersant, a crosslinking agent, and a crosslinking accelerator were added to a polymer solution obtained by dissolving a polymer in butyl cellosolve acetate, thereby preparing a liquid composition (liquid composition preparation step). Next, a delamination treatment of pressurizing the liquid composition and causing the liquid composition to pass through a nozzle was performed (delamination treatment step). For the delamination treatment, a wet jet mill (“Nanovater (registered trademark)” manufactured by Yoshida Kikai Co., Ltd.) was used. The delamination treatment using the wet jet mill was performed by pressurizing the liquid composition to 130 MPa and using a collision-type nozzle (cross-type nozzle) with a nozzle diameter of 170 μm. The number of times pressurization and passing through the nozzle were performed was once in Example 1, three times in Example 2, and five times in Example 3. The liquid composition after the delamination treatment was applied to a base material by a bar coating method to achieve the target thickness value of 20 μm and was heated at 150° C. for 2 hours, thereby hardening the coated film (hardening step). As base materials, two types, namely a PET sheet and a thermoplastic elastomer sheet (“Esmer (registered trademark) URS” manufactured by Nihon Matai Co., Ltd., thickness of 0.2 mm) were used.

[Method for Manufacturing Electroconductive Films in Examples 4 to 6]

Electroconductive films were manufactured similarly to the method for manufacturing the electroconductive films in Examples 1 to 3 except that the nozzle shape was changed to a straight type (I type). The numbers of times the passing was caused were once in Example 4, three times in Example 5, and five times in Example 6.

[Method for Manufacturing Electroconductive Films in Examples 7 to 10]

Electroconductive films were manufactured similarly to the method for manufacturing the electroconductive films in Examples 1 to 3 except that the nozzle diameter was changed to 600 μm and in Examples 8 and 9, the numbers of times the pressurizing and the passing through the nozzle were changed. The numbers of times the passing was caused were once in Example 7, twice in Example 8, four times in Example 9, and five times in Example 10.

[Method for Manufacturing Electroconductive Films in Examples 11 to 13]

Electroconductive films were manufactured similarly to the method for manufacturing the electroconductive films in Examples 1 to 3 except that the nozzle diameter was changed to 375 μm and the pressures and the numbers of times the pressurization and the passing through the nozzle were performed were changed. The pressures for pressurizing the liquid composition were 60 MPa in Example 11, 130 MPa in Example 12, and 200 MPa in Example 13. The numbers of times the passing was caused were five times in Example 11, five times in Example 12, and three times in Example 13.

[Method for Manufacturing Electroconductive Film in Comparative Example 1]

First, a kneading treatment was conducted on a liquid composition prepared similarly to Example 1 three times using three rolls. Next, the liquid composition after the kneading treatment was applied to a base material similarly to Example 1, and the coated film was hardened, thereby manufacturing an electroconductive film.

Method for Manufacturing Electroconductive Film in Comparative Example 2

An electroconductive film was manufactured similarly to the method for manufacturing the electroconductive film in Comparative Example 1 except that the electroconductive agent was changed to expanded graphite powder A.

[Method for Manufacturing Electroconductive Films in Comparative Examples 3 to 5]

Electroconductive films were manufactured similarly to the method for manufacturing the electroconductive films in Examples 1 to 3 except that the electroconductive agent was changed to expanded graphite powder A. The numbers of times the passing was caused were once in Comparative Example 3, three times in Comparative Example 4, and five times in Comparative Examples 5.

[Method for Manufacturing Electroconductive Film in Comparative Example 6]

An electroconductive film was manufactured similarly to the method for manufacturing the electroconductive film in Comparative Example 1 except that the electroconductive agent was changed to expanded graphite powder B.

[Method for Manufacturing Electroconductive Films in Comparative Examples 7 to 9]

Electroconductive films were manufactured similarly to the method for manufacturing the electroconductive films in Examples 1 to 3 except that the electroconductive agent was changed to expanded graphite powder B. The numbers of times the passing was caused were once in Comparative Example 7, three times in Comparative Example 8, and five times in Comparative Example 9.

TABLE 1

| | | Compar- | | | | | | |
|---|---|---|---|---|---|---|---|---|
| | | ative | | | | | | |
| | | Exam- | Exam- | Exam- | Exam- | Exam- | Exam- | Exam- |
| Material [Unit: parts by mass] | | ple 1 | ple 1 | ple 2 | ple 3 | ple 4 | ple 5 | ple 6 |
| Polymer | Epoxy group-modified acrylic rubber | 68 | 68 | 68 | 68 | 68 | 68 | 68 |
| Electroconductive | Thinned graphite powder | 35 | 35 | 35 | 35 | 35 | 35 | 35 |
| agent | Expanded graphite powder A | — | — | — | — | — | — | — |
| | (average particle diameter of 211.7 μm) | | | | | | | |
| | Expanded graphite powder B | — | — | — | — | — | — | — |
| | (average particle diameter of 38.4 μm) | | | | | | | |
| Dispersant | High-molecular-weight polyester | 25 | 25 | 25 | 25 | 25 | 25 | 25 |
| | acid amide amine salt | | | | | | | |
| Crosslinking agent | Amino group terminated butadiene- | 6 | 6 | 6 | 6 | 6 | 6 | 6 |
| | acrylonitrile copolymer | | | | | | | |
| Crosslinking accelerator | Zink complex | 1 | 1 | 1 | 1 | 1 | 1 | 1 |
| Solvent | | Butyl cellosolve acetate | | | | | | |
| Solid content (%) | | 22 | | | | | | |
| Treatment method | Device | Three rolls | Wet jet mill | | | | | |
| | Nozzle shape | — | Collision type | | | Straight type | | |
| | Nozzle diameter | | 170 μm | | | 170 μm | | |
| | Pressure | | 130 MPa | | | | | |
| | Number of times of passing | 3 | 1 | 3 | 5 | 1 | 3 | 5 |
| Evaluation | Initial electric resistance [Ω · cm] | 0.117 | 0.014 | 0.014 | 0.016 | 0.016 | 0.018 | 0.018 |
| | Maximum change magnification of | 39 | 36 | 22 | 17 | 44 | 29 | 32 |
| | electric resistance value in extension | | | | | | | |
| | durability test | | | | | | | |
| | Maximum volume resistivity in | 4.55 | 0.50 | 0.31 | 0.27 | 0.73 | 0.53 | 0.59 |
| | extension durability test [Ω · cm] | | | | | | | |

TABLE 2

| | | Exam- | Exam- | Exam- | Exam- | Exam- | Exam- | Exam- |
|---|---|---|---|---|---|---|---|---|
| Material [Unit: parts by mass] | | ple 7 | ple 8 | ple 9 | ple 10 | ple 11 | ple 12 | ple 13 |
| Polymer | Epoxy group-modified acrylic rubber | 68 | 68 | 68 | 68 | 68 | 68 | 68 |
| Electroconductive | Thinned graphite powder | 35 | 35 | 35 | 35 | 35 | 35 | 35 |
| agent | Expanded graphite powder A | — | — | — | — | — | — | — |
| | (average particle diameter of 211.7 μm) | | | | | | | |
| | Expanded graphite powder B | — | — | — | — | — | — | — |
| | (average particle diameter of 38.4 μm) | | | | | | | |
| Dispersant | High-molecular-weight polyester | 25 | 25 | 25 | 25 | 25 | 25 | 25 |
| | acid amide amine salt | | | | | | | |
| Crosslinking agent | Amino group terminated butadiene- | 6 | 6 | 6 | 6 | 6 | 6 | 6 |
| | acrylonitrile copolymer | | | | | | | |
| Crosslinking accelerator | Zink complex | 1 | 1 | 1 | 1 | 1 | 1 | 1 |
| Solvent | | Butyl cellosolve acetate | | | | | | |
| Solid content (%) | | 22 | | | | | | |
| Treatment method | Device | Wet jet mill | | | | | | |
| | Nozzle shape | Collision type | | | | | | |
| | Nozzle diameter | 600 μm | | | | 375 μm | | |
| | Pressure | 130 MPa | | | | 60 MPa | 130 MPa | 200 MPa |
| | Number of times of passing | 1 | 2 | 4 | 5 | 5 | 5 | 3 |
| Evaluation | Initial electric resistance [Ω · cm] | 0.015 | 0.017 | 0.018 | 0.022 | 0.018 | 0.019 | 0.022 |
| | Maximum change magnification | 40 | 38 | 42 | 36 | 40 | 35 | 36 |
| | of electric resistance value in | | | | | | | |
| | extension durability test | | | | | | | |
| | Maximum volume resistivity in | 0.62 | 0.66 | 0.78 | 0.81 | 0.72 | 0.67 | 0.79 |
| | extension durability test [Ω · cm] | | | | | | | |

TABLE 3

| | | Compar- | Compar- | Compar- | Compar- | Compar- | Compar- | Compar- | Compar- |
|---|---|---|---|---|---|---|---|---|---|
| | | ative | ative | ative | ative | ative | ative | ative | ative |
| | | Exam- | Exam- | Exam- | Exam- | Exam- | Exam- | Exam- | Exam- |
| Material [Unit: parts by mass] | | ple 2 | ple 3 | ple 4 | ple 5 | ple 6 | ple 7 | ple 8 | ple 9 |
| Polymer | Epoxy group-modified acrylic rubber | 68 | 68 | 68 | 68 | 68 | 68 | 68 | 68 |
| Electro- | Thinned graphite powder | — | — | — | — | — | — | — | — |
| conductive | Expanded graphite powder A | 35 | 35 | 35 | 35 | — | — | — | — |
| agent | (average particle diameter of 211.7 μm) | | | | | | | | |
| | Expanded graphite powder B | — | | — | — | 35 | 35 | 35 | 35 |
| | (average particle diameter of 38.4 μm) | | | | | | | | |
| Dispersant | High-molecular-weight polyester | 25 | 25 | 25 | 25 | 25 | 25 | 25 | 25 |
| | acid amide amine salt | | | | | | | | |
| Crosslinking | Amino group terminated | 6 | 6 | 6 | 6 | 6 | 6 | 6 | 6 |
| agent | butadiene-acrylonitrile copolymer | | | | | | | | |
| Crosslinking | Zink complex | 1 | 1 | 1 | 1 | 1 | 1 | 1 | 1 |
| accelerator | | | | | | | | | |
| Solvent | | Butyl cellosolve acetate | | | | | | | |
| Solid content (%) | | 22 | | | | | | | |
| Treatment | Device | Three rolls | Wet jet mill | | | Three rolls | Wet jet mill | | |
| method | Nozzle shape | — | Collision type | | | — | Collision type | | |
| | Nozzle diameter | | 170 μm | | | | 170 μm | | |
| | Pressure | | 130 Mpa | | | | 130 Mpa | | |
| | Number of times of passing | 3 | 1 | 3 | 5 | 3 | 1 | 3 | 5 |
| Evaluation | Initial electric resistance [Ω · cm] | 0.980 | 0.363 | 0.056 | 0.030 | 0.187 | 1.202 | 4.214 | 1.500 |
| | Maximum change magnification of | >251 | >251 | 34 | 35 | 139 | >251 | >251 | >251 |
| | electric resistance value in | | | | | | | | |
| | extension durability test | | | | | | | | |
| | Maximum volume resistivity in | >91 | >91 | 1.90 | 1.04 | 26.11 | >91 | >91 | >91 |
| | extension durability test [Ω · cm] | | | | | | | | |

<Method for Evaluation Electroconductive Films>

[Initial Volume Resistivity]

Volume resistivities of the electroconductive films with the thickness of 20 μm formed on PET sheets were measured using a low-resistance meter “Loresta (registered trademark) GP” (voltage: 5V, conforming to JIS K7194: 1994) manufactured by Mitsubishi Chemical Analytech Co., Ltd. The measured volume resistivities were assumed to be initial (before extension) volume resistivities.

[Maximum Volume Resistivities in Extension Durability Test]

Samples with the electroconductive films with the thicknesses of 20 μm formed on thermoplastic elastomer sheets were cut into Dumbbell shape No. 2 defined by JIS K6251: 2010, thereby producing test pieces. Copper foils were attached at positions corresponding to 10 mm from both ends of each test piece. A pair of benchmarks were drawn at positions corresponding to 10 mm on both sides from the center of each test piece in the longitudinal direction, and a distance of 20 mm between the benchmarks was set on each test piece. First, an electric resistance value R1 between the copper foils when a voltage of 1 V was applied was measured. Next, one end of each test piece was pulled and extended such that the distance between the benchmarks became 30 mm (extension rate of 50%), and the test piece was recovered to an original state. The extension was repeated 25000 times at a frequency of 2 Hz while the voltage of 1 V was applied, and an electric resistance value between the copper foils was measured. A maximum value R2 of the measured electric resistance values was divided by the electric resistance value R1, thereby calculating a maximum change magnification (R2/R1). Then, the calculated maximum change magnification was multiplied by the aforementioned initial volume resistivity, thereby obtaining a maximum volume resistivity in the extension durability test.

<Results of Evaluating Electroconductive Films>

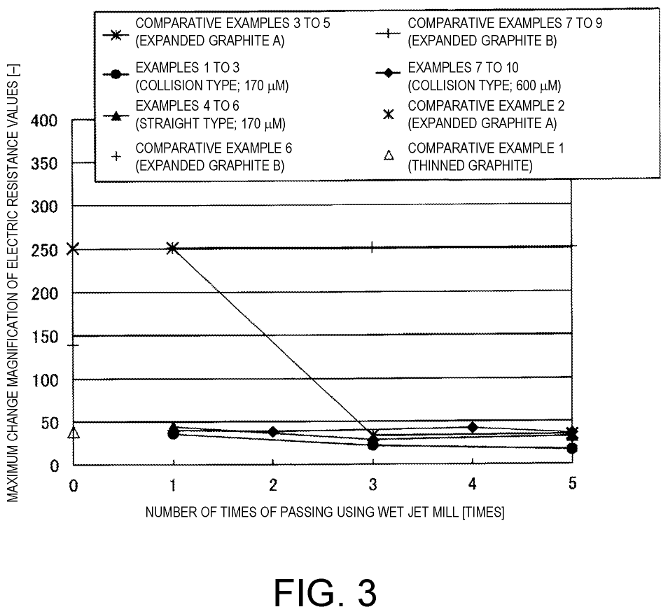

Table 1 shown above collectively presents results of evaluating the electroconductive films in Examples 1 to 6 and Comparative Example 1. Table 2 collectively represents results of evaluating the electroconductive films in Examples 7 to 13. Table 3 collectively represents results of evaluating the electroconductive films in Comparative Examples 2 to 9. FIG. 1 illustrates a graph of initial volume resistivities of the respective electroconductive films except for those in Examples 11 to 13 (the same applies to FIGS. 2 and 3). FIG. 2 illustrates a graph of maximum volume resistivities in the extension durability test of the respective electroconductive films. FIG. 3 illustrates a graph of the maximum change magnifications (R2/R1) of the electric resistance values in the extension durability test of the respective electroconductive films. In FIGS. 1 to 3, the horizontal axis represents the number of times (the number of times of passing) the pressurizing and the passing through the nozzle were performed using the wet jet mill. A plot when the number of times the passing was performed was zero corresponds to the value in Comparative Examples 1, 2, and 6 in which a kneading treatment using three rolls was performed without performing a delamination treatment using a wet jet mill. Also, since the maximum value R2 of the electric resistance values when extension was repeated exceeded a measurement limit in the extension durability test in Comparative Examples 2, 3, and 7 to 9, the value calculated from a measurable maximum value is shown as a maximum change magnification and a maximum volume resistivity.

As shown in Tables 1 and 2, the initial volume resistivities were as small as 0.022 Ω·cm or less in the electroconductive films in Examples 1 to 13. Also, the maximum change magnifications of the electric resistance values during the extension durability test were equal to or less than 42, and the maximum volume resistivities were as small as 0.81 Ω·cm or less. The initial volume resistivities hardly changed regardless of an increase in the numbers of times the passing was caused (even after the delamination treatment was repeated). Although variations in the maximum change magnifications of the electric resistance values during the extension durability test that accompanied an increase in the numbers of times the passing was caused were small, there was a trend that the maximum change magnifications lightly decreased as the numbers of times the passing was caused increased. It was possible to manufacture electroconductive films that had high electroconductivity and had electric resistances unlikely to increase even after repeated extension merely by performing the delamination treatment once (that is, through a treatment in a short length of time) if the thinned graphite was used in this manner.

In comparison between Examples 1 to 3 and Examples 4 to 6 in which only the nozzle shapes were different, the maximum change magnifications and the maximum volume resistivities were smaller when the collision-type nozzle was used in a case in which the numbers of times the passing was caused were the same. This is considered to be because a larger shear force was applied to the liquid composition due to collision in the liquid composition and delamination of the thinned graphite further advanced if the collision-type nozzle was used. Also, in comparison between Examples 1 to 3 and Examples 7 to 10 and 12 in which only the nozzle diameters were different, the maximum change magnifications and the maximum volume resistivities were smaller when the nozzle with a smaller diameter was used in a case in which the numbers of times the passing was caused were the same. This is considered to be because the flow rate of the liquid composition increased, turbulence further easily occurred, a larger shear force was applied to the liquid composition, and delamination of the thinned graphite further advanced, as the nozzle diameter was smaller in a case in which the pressures applied when the fluid was pressure-fed to the nozzle were the same.

In comparison between Example 11 and Example 12 in which only pressures for pressurizing the liquid composition were different, the maximum change magnification and the maximum volume resistivity were smaller in Example 12 in which the pressure was larger. This is considered to be because the flow rate increased as the pressure increased and the shear force applied to the thinned graphite thus increased. Further, electroconductivity in an equivalent level was achieved in Example 13 in which the pressure was further larger regardless of the fact that the smaller number of times the passing was caused than in Examples 11 and 12.

Meanwhile, the initial volume resistivity of the electroconductive film in Comparative Example 1 in which the same thinned graphite as that in Example 1 and the like was used without performing the delamination treatment thereon was larger than those of the electroconductive films in Examples 1 to 13. Also, the maximum volume resistivity during the extension durability test was significantly larger than those of the electroconductive films in Examples 1 to 13. In this manner, since the thinning was not adequate, there was a limit in an improvement in electroconductivity even if the thinned graphite was used.

In the electroconductive films in Comparative Examples 2 to 9, expanded graphite was used as a material rather than thinned graphite. In this case, the initial volume resistivities and the maximum volume resistivities during the extension durability test were larger than those in Examples 1 to 13 even though the delamination treatment was performed as in Comparative Examples 3 to 5 and 7 to 9. In the electroconductive films in Comparative Examples 7 to 9 using the expanded graphite powder B with a smaller particle diameter, in particular, no improvement in electroconductivity was observed even after the delamination treatment was repeated.

As described above, it was confirmed that an electroconductive film that has high initial electroconductivity and has electric resistance unlikely to increase even after repeated extension was manufactured by the manufacturing method according to the invention. Also, it was confirmed to be possible to perform a graphite thinning treatment in a shorter length of time and to efficiently manufacture the electroconductive film according to the manufacturing method in the invention.

The electroconductive film manufactured by the manufacturing method according to the disclosure is suitable for an electromagnetic wave shield, a flexible wiring board, and the like used in a wearable device or the like in addition to an electrode and a wiring used in a flexible transducer. Utilization of the electroconductive film manufactured by the manufacturing method according to the disclosure for an electrode or a wiring makes it possible to improve durability of an electronic device mounted on a flexible portion such as a movable portion of a robot, nursing care equipment, an interior of a transport device, or the like.

Other Configurations

In view of the above description, other configurations of the disclosure can provide a method for manufacturing an electroconductive film including: a liquid composition preparation step of preparing a liquid composition including an electroconductive agent, an elastomer, and a solvent, the electroconductive agent having thinned graphite in which layers of graphite are thinned and which has a bulk density of equal to or less than 0.05 g/cm³; a delamination treatment step of performing interlayer delamination of the thinned graphite by pressurizing the liquid composition and causing the liquid composition to pass through a nozzle; and a hardening step of coating a substrate with the delamination-treated liquid composition and hardening a coated film.

As described in Patent Literatures 2 to 5 above, interlayer delamination of graphite is performed through either a high-temperature high-pressure treatment of bringing graphite into contact with a supercritical fluid or a subcritical fluid or a high-pressure emulsification treatment of graphite in the related art. Meanwhile, the method for manufacturing an electroconductive film according to the disclosure is adapted such that a liquid composition is prepared using thinned graphite and a delamination treatment of further performing interlayer delamination of the thinned graphite is performed. The thinned graphite is graphite that has undergone interlayer delamination in advance and has been formed in the form of thin layers. Since the delamination treatment is further performed on the thinned graphite, the graphite is thinned in two stages in the method for manufacturing an electroconductive film according to the invention. In this manner, it is possible to adequately thin the graphite. Also, the bulk density of the thinned graphite is equal to or less than 0.05 g/cm³. The thinned graphite further spreads between layers as compared with typical graphite, and the bulk density thereof is small. Therefore, the interlayer delamination easily occurs in the thinned graphite. According to the method for manufacturing an electroconductive film in the invention, it is possible to shorten a delamination treatment time since the delamination treatment is performed on the thinned graphite in an easily delaminated state. Also, an elastomer is included in the liquid composition in addition to the electroconductive agent. In this manner, it is possible to prevent the graphite formed in the form of thin layers from aggregating during the delamination treatment and formation of the coated film.

The delamination treatment is performed by pressurizing a liquid composition including the thinned graphite and causing the liquid composition to pass through a nozzle. In this manner, delamination due to a shear force further advances as compared with miniaturization of the thinned graphite through pulverization, and it is possible to cause the thinning to advance while maintaining the size (the width and the length) in a plane direction. If the delamination treatment is performed on the liquid composition, the thinned graphite is turned into multilayer graphene with a smaller number of layers of graphene. The multilayer graphene has a thin thickness while the size thereof in the plane direction is maintained. Therefore, the multilayer graphene has a larger aspect ratio (the width or the length/the thickness) than the thinned graphite. In this manner, the multilayer graphene particles easily come into contact with each other in the electroconductive layer, and a conductive path is easily formed. Also, the conductive path is not easily disconnected even when extended by the multilayer graphene being oriented in the plane direction. Therefore, according to the manufacturing method in the invention, it is possible to manufacture a conductive film that has high initial (before extension) electroconductivity and in which electrical resistance is unlikely to increase even after repeated extension.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A method for manufacturing an electroconductive film, comprising:
a liquid composition preparation step of preparing a liquid composition including an electroconductive agent, an elastomer, and a solvent, the electroconductive agent having thinned graphite in which layers of graphite are thinned and which has a bulk density of equal to or less than 0.05 g/cm³;
a delamination treatment step of performing interlayer delamination of the thinned graphite by pressurizing the liquid composition and causing the liquid composition to pass through a nozzle; and
a hardening step of coating a substrate with the delamination-treated liquid composition and hardening a coated film.

2. The method for manufacturing an electroconductive film according to claim 1, wherein a shape of the nozzle is a collision type or a straight type.

3. The method for producing an electroconductive film according to claim 1, wherein, in the delamination treatment step, the liquid composition is pressurized with a pressure of equal to or greater than 60 MPa and equal to or less than 200 MPa and is caused to pass through the nozzle.

4. The method for producing an electroconductive film according to claim 2, wherein, in the delamination treatment step, the liquid composition is pressurized with a pressure of equal to or greater than 60 MPa and equal to or less than 200 MPa and is caused to pass through the nozzle.

5. The method for manufacturing an electroconductive film according to claim 1, wherein, in the delamination treatment step, the delamination treatment of pressurizing the liquid composition and causing the liquid composition to pass through the nozzle is performed once or is repeated a number of times equal to or greater than two and equal to or less than five.

6. The method for manufacturing an electroconductive film according to claim 2, wherein, in the delamination treatment step, the delamination treatment of pressurizing the liquid composition and causing the liquid composition to pass through the nozzle is performed once or is repeated a number of times equal to or greater than two and equal to or less than five.

7. The method for manufacturing an electroconductive film according to claim 1, wherein the delamination treatment step is performed using a wet jet mill.

8. The method for manufacturing an electroconductive film according to claim 2, wherein the delamination treatment step is performed using a wet jet mill.

9. The method for manufacturing an electroconductive film according to claim 1, wherein the thinned graphite is a powder with an average particle diameter of equal to or greater than 45 μm.

10. The method for manufacturing an electroconductive film according to claim 2, wherein the thinned graphite is a powder with an average particle diameter of equal to or greater than 45 μm.

11. The method for manufacturing an electroconductive film according to claim 1, further comprising, as a step of manufacturing the thinned graphite:
a contact step of bringing an intercalant in a supercritical state or a subcritical state into contact with the graphite and causing the intercalant to enter between the layers of the graphite; and
a gasification step of gasifying the intercalant that has entered between the layers of the graphite.

12. The method for manufacturing an electroconductive film according to claim 2, further comprising, as a step of manufacturing the thinned graphite:
a contact step of bringing an intercalant in a supercritical state or a subcritical state into contact with the graphite and causing the intercalant to enter between the layers of the graphite; and
a gasification step of gasifying the intercalant that has entered between the layers of the graphite.

13. The method for manufacturing an electroconductive film according to claim 11, wherein the graphite comprises expanded graphite.

14. The method for manufacturing an electroconductive film according to claim 12, wherein the graphite comprises expanded graphite.

15. The method for manufacturing an electroconductive film according to claim 1, wherein the liquid composition comprises a dispersant.

16. The method for manufacturing an electroconductive film according to claim 2, wherein the liquid composition comprises a dispersant.

17. The method for manufacturing an electroconductive film according to claim 1, wherein an amount of the thinned graphite blended in the electroconductive agent is equal to or greater than 20 parts by mass and equal to or less than 60 parts by mass when an entire solid content except for the electroconductive agent is set to be 100 parts by mass.

18. The method for manufacturing an electroconductive film according to claim 2, wherein an amount of the thinned graphite blended in the electroconductive agent is equal to or greater than 20 parts by mass and equal to or less than 60 parts by mass when an entire solid content except for the electroconductive agent is set to be 100 parts by mass.
